(19) United States
(12) Patent Application Publication
(10) Pub. No.: US 2018/0369893 A1
(43) Pub. Date: Dec. 27, 2018

(54) WEDGE DRIVE

(71) Applicant: Harald Weigelt, Kürten (DE)

(72) Inventor: Harald Weigelt, Kürten (DE)

(21) Appl. No.: 16/063,997

(22) PCT Filed: Dec. 21, 2016
(86) PCT No.: PCT/EP2016/082204

§ 371 Date: Jun. 19, 2018

(30) Foreign Application Priority Data
Dec. 21, 2015 (DE) 20 2015 106 966.9

(51) Int. Cl. B21D 28/32; B30B 1/40

(52) U.S. Cl. CPC B21D 28/325; B30B 1/40

(57) ABSTRACT

This invention relates to a wedge drive 1 for converting a vertical press force into a horizontal linear working movement, the wedge drive 1 comprising a slider element 2, a driver element 4 and a slider element receptacle 3, wherein the slider element 2 is placed vertically between the driver element 4 and the slider element receptacle 3, wherein the slider element 2 and the slider element receptacle 3 are designed as two guiding elements 2, 3 on which a sliding plate formation 5, 6, 7 is placed, wherein the sliding plate formation is surrounded by a guiding device that is designed for the linear guiding of the slider element 2 along the slider element receptacle 3 in a sliding direction X. The guiding device comprises a central element that is provided on a first of the two guiding elements 2, 3 on its side pointing to a second of the two guiding elements 2, 3, wherein the sliding plate formation 5, 6, 7 comprises at least two side sliding plates 5, 6 that are fixed to a second of the two guiding elements 2, 3 and that are spaced from each other in a cross direction Y that is perpendicular to the sliding direction X, wherein the central element 7 is placed in the cross direction between the side sliding plates 5, 6, wherein the second guiding element 2, 3 has two steps spaced from each other in the cross direction Y, wherein each of the two side sliding plates 5, 6 closely fits to respectively one of the two steps with a form fit acting in the cross direction Y.

This invention relates to a wedge drive for converting a high vertical press force of in particular over 100 kN into a horizontal linear working movement according to the preamble of claim 1.

Generic wedge drives are mainly used in forming processes in which materials must be formed with a very high expenditure of force and with the greatest precision. The main application field of such wedge drives is the automotive industry. In this case, the wedge drives are used, for example, for manufacturing car bodies, in particular for processing massive sheet metal parts such as, for example, for trimming, punching or deforming sheet metal parts. For such a processing of sheet metal parts, working movements with extremely high working pressures that can easily exceed 1000 kN have to be executed. Simultaneously, such working movements have to be carried out with an extremely high precision since only then the necessary fit accuracy of the car body parts manufactured herewith can be ensured.

It has shown that generic wedge drives are very well appropriate to meet said requirements for the manufacturing of car body parts. The wedge drives are used here in a pressing tool. The pressing tool comprises a press that exerts an extremely high pressing force in the vertical direction onto the wedge drive. Depending on the forming process and the wedge drive used for that purpose, the vertical press force that the press exerts onto the wedge drive, is at least 100 kN, in particular at least 500 kN and in particular between 1000 and 50000 kN. The wedge drives are designed in such a way that they can resist to such a press force and can convert the vertical pressing movement with which the vertical press force is exerted onto them into a horizontal linear working movement. With the working movement, a working force can then be applied that is lower by a certain percentage than the vertical press force exerted onto the wedge drive, depending on the specific configuration of the wedge drive. An essential feature of generic wedge drives consists here in that the working movement is effectively linear because only then a wedge drive can ensure a sufficient precision for carrying out a forming process.

For meeting the requirements placed on them in a pressing tool, generic wedge drives are designed in such a manner that they comprise a driver element, a slider element and a slider element receptacle. The slider element receptacle is designed to absorb the vertical press force that is exerted by the vertical movement of the press. The slider element receptacle is thus designed in such a way so as to be fixed in a fixed position on a movable press element of a press with which the press exerts the vertical pressing movement. The driver element is designed in such a way that it is fixed immovably in a fixed position at a vertical distance from the slider element receptacle, in particular on a base element of the pressing tool provided for that purpose. The slider element is placed vertically between the slider element receptacle and the driver element and is fixed to the slider element receptacle so as to be able so slide linearly. In operating condition, it bears on the driver element with a bearing force caused by the press force and is also linearly movable on the driver element. For this purpose, a linear driver guide is provided between the driver element and the slider element as well as a guiding device between the slider element receptacle and the slider element, wherein the angle between the linear direction of the driver guide and the linear direction of the guiding device can be purposefully selected. The driver guide is designed to ensure a linear guiding direction of the slider element along the driver element in a driver sliding direction, and the guiding device is designed to ensure a linear guiding direction of the slider element along the slider element receptacle in a sliding direction. The driver sliding direction and the sliding direction form here an angle with each other and to the vertical direction and are both situated in a plane in which the vertical direction is also situated. The angle that the driver sliding direction forms with the sliding direction is usually in a range between 30° and 120°. If such a generic wedge drive is inserted into a pressing tool for the purpose for which it is intended and if the press carries out a pressing movement, the slider element receptacle that is connected with the movable press element moves in the vertical direction, whereas the driver element remains immovable. The slider element receptacle is thus moved in the vertical direction with respect to the driver element. This causes a horizontal linear working movement of the slider element that is connected with the slider element receptacle by the guiding device and with the driver element by the driver guide and that thus carries out the linear horizontal working movement. The conversion of the vertical press movement into a horizontal working movement takes place due to the fact that the sliding direction and the driver sliding direction form an angle of >0° to each other as well as to the vertical direction. Wedge drives with different angles between the sliding direction and the driver sliding direction as well as between the sliding direction and the vertical direction or driver sliding direction and vertical direction are known by the prior art. These angles of the wedge drive are chosen with regard to the inclination angle of a component or of a car body part to be processed. In this respect, the automotive industry agreed to increments of 5 degrees. Should a flange with a downwards inclination below 37° be trimmed, a wedge drive with a direction of the working movement of 50 to 55° could, for example, be used. Furthermore, the length of the sliding path of the slider element in the horizontal direction is determined by the setting of these angles when the slider element receptacle travels over a certain path length in the vertical direction. Moreover, the extent of the transmission of force from the vertical press force to the horizontal working force is determined by the angles. This being, the horizontal direction (direction of the working movement) must not necessarily be 90° to the vertical direction but can have an angle between 40° and 130° to the vertical direction.

A major problem of the implementation of generic wedge drives consists in the design of the guides between the slider element and the slider element receptacle or between the slider element and the driver element in such a manner that a linear working movement that is as precise as possible can be ensured when high pressing forces are exerted onto the wedge drive. It is in particular desired that the working movement also remains as exactly linear as possible when the slider element that carries out the working movement is loaded with a component vertically to the horizontal direction in which it carries out the working movement. Because such a load very often takes place when the wedge drive is used for forming components, for example when a forming die that is fixed to the slider element hits a curved surface of the component during the forming process. This being, forces arising transversely to the linear working movement that arise, for example, during beveling or working steps performed obliquely from top to bottom, should ideally be absorbed by the wedge drive without the linearity of the working movement being impaired. The guiding device between the slider element receptacle and the slider element is particularly critical for complying with a working movement as exactly linear as possible.

Various possibilities are known by the prior art to design the guiding device in such a way that it ensures a sufficiently precise guiding and simultaneously a sufficient load-bearing capacity. The basic principle that applies for generic wedge drives for implementing the guiding device always consists in that the guiding device is implemented with a sliding plate formation, the sliding plates of which are chamfered and oriented to each other in such a way that a centering of the slider element inside the sliding plate formation is ensured if the slider element receptacle exerts a vertical force onto the slider element. In the prior art, such guiding devices are implemented in such a way that they have a cross-section perpendicular to the sliding direction that has the shape of a prism or the shape of a dovetail.

Such generic wedge drives certainly sufficiently indeed meet the requirements placed upon them. Nevertheless, the manufacturing of such generic wedge drives is extremely complicated and cost-intensive because of the chamfered guiding surfaces of the guiding device. To renounce correspondingly chamfered guiding surfaces in order to reduce the expenditure and the costs incurred by the manufacturing of a wedge drive however proved to be not practicable since then the precision and the load-bearing capacity of the wedge drive so much decreases that the wedge drive cannot be used any more for the precise manufacturing of components. Thus, the prior art lacks a fundamental principle with which precisely working loadable wedge drives can be implemented without an extremely high expenditure and extremely high costs being necessary for that purpose.

Thus, the objective technical aim of this invention is to make available a wedge drive that can be manufactured as easily and cost-effectively as possible and that simultaneously meets the above-mentioned requirements in the best possible way.

As a solution to said aim of the invention, the invention proposes a wedge drive with the characteristics of claim 1. The wedge drive comprises a slider element, a driver element and a slider element receptacle. The slider element is placed in a vertical direction between the driver element and the slider element receptacle. The slider element and the slider element receptacle are designed as two guiding elements on which a slide plate formation is placed for providing a guiding device for the linear guiding of the slider element along the slider element receptacle in a sliding direction. The guiding device comprises the sliding plate formation. The sliding direction has an angle between 10° and 80°, in particular between 20° and 70° to the vertical direction. The guiding device comprises a central element that is provided on a first of the two guiding elements on its side pointing to the second guiding element. The sliding plate formation comprises at least two sliding plates that are designed as side sliding plates and that are fixed to a second of the two guiding elements. For example, the central element can be fixed to the slider element and the side sliding plates to the slider element receptacle. For example, le central element can be fixed to the slider element receptacle and the side sliding plates to the slider element. The side sliding plates are spaced from each other in a cross direction that is perpendicular to the sliding direction and in particular also perpendicular to the vertical direction and the central element is placed in the cross direction between the side sliding plates. Thus, the side sliding plates rim the central element, this being seen in the cross direction. The side sliding plates are preferably designed as sliding plates manufactured separately from the second guiding element and fixed to the second guiding element. Screws can for example, carry out the fixing. The side sliding plates are designed in such a manner that the first guiding element can slide along them without high frictional forces being involved. For example, the side sliding plates can be designed as sliding plates made of bronze. The central element can, for example, be integrally fitted with the first guiding element, for example can be designed as a one-part component with the first guiding element, for example as a metal casting part. Due to the implementation of the central element in such a way that the central element and the first guiding element are integrally manufactured as a one-part component, the manufacturing of the wedge drive can be particularly simplified. In another embodiment, the central element can be designed as a separate component from the first guiding element, component that is fixed on the first guiding element, for example by screws. For example, the central element can be designed as a central sliding plate so that the second guiding element can slide along the central sliding plate with as little friction as possible. For example, the central sliding plate can be designed as a sliding plate made of bronze. Due to the design of the central element as a central sliding plate, the friction during a relative sliding of the slider element to the slider element receptacle along the sliding direction between the two guiding elements can be particularly significantly reduced.

The second guiding element has two steps spaced from each other in the cross direction, wherein each of the two side sliding plates closely fits to respectively one of the two steps with a form fit acting in the cross direction. Both steps are thus opposite to each other in the cross direction. A first of the two side sliding plates thus bears with a section of its surface on a surface section of a first of the two steps and a second of the two side sliding plates bears with a section of its surface on a surface section of a second of the two steps. If a force is applied to the first side sliding plate towards the first step in the cross direction, the form fit prevents the first side sliding plate from sliding in the cross direction. If a force is applied to the second side sliding plate towards the second step in the cross direction, the form fit prevents the second side sliding plate from sliding in the cross direction. Thus the form fit prevents the first side sliding plate from sliding when the central element exerts a force onto the first side sliding plate in a positive direction along the cross direction, while the form fit between the second side sliding plate and the second step prevents the second side sliding plate from sliding when the central element exerts a force onto the second side sliding plate in a negative direction along the cross direction. The form fit is respectively ensured by the step that is designed in the second guiding element in particular in that a height difference is provided between two surface sections that are respectively plane and spanned across the sliding direction and the cross direction, this height difference being implemented by a plane surface that extends along a transverse cross direction that is perpendicular to the cross direction and perpendicular to the sliding direction and that is spanned in particular across the sliding direction and the transverse cross direction. Thus, the form fit between the first side sliding plate and the first step acts unidirectionally in a positive direction along the cross direction and the form fit between the second side sliding plate and the second step acts unidirectionally in a negative direction along the cross direction while the central element is connected with the first guiding element so as to be protected against sliding in two directions in the positive as well as in the negative direction along the cross direction, in particular is designed in one piece with this guiding element. Here, in general it should be noted that “to prevent from a movement with a form fit” always means that a movement is avoided whenever the material employed makes it possible. Moreover, it should be referred here to the self-evident fact of which the skilled in the art is aware that the form fit refers to an application of force that takes place at the level of the surface or of the surface section of the side sliding plate and of the step with which the respective elements are in contact for providing the form fit since it can otherwise come to a tilting of the elements to each other about an axis of rotation perpendicularly to the cross direction. Thus, the form fit prevents from a movement in the cross direction for which it does not simultaneously come to a rotation of the elements about an axis of rotation perpendicularly to the cross direction. In general, at least one or all the sliding plates, in particular the two side sliding plates and/or the central sliding plate provided as a central element, can be designed as one part components. The load-bearing capacity and the precision of the wedge drive can thus be further improved and the manufacturing costs thus can be further reduced.

Due to the interaction of its characteristics even under a significant load by the press force, a wedge drive according to the invention has thus a very simple structure and makes possible a precise linear guiding of the slider element for carrying out a precise linear working movement of the slider element. The interaction of the characteristics is based in particular on the fact that the central element is maintained in the first cross direction stable in two directions on the first guiding element, while the side sliding plates are maintained by their form fits stable to the second guiding element while the central element is placed in the cross direction between the side sliding plates and bears in particular directly on the side sliding plates, wherein the central element and the side sliding plate are preferably formed in one piece. Thus, the side sliding plates form a guiding frame acting in the cross direction for the central element, guiding frame in which the central element is securely guided. Since the central element is securely guided by the side sliding plates in the cross direction and the side sliding plates are securely guided on the second guiding element and the central element is securely guided on the first guiding element, the first guiding element is thus securely guided with respect to the second guiding element, i.e. the slider element is securely guided in the cross direction to the slider element receptacle. A movement of the slider element to the slider element receptacle in the cross direction can thus at least as far as possible be avoided. Since furthermore the press exerts a pressing force perpendicularly to the cross direction in the vertical direction during the carrying out of a working movement of the slider element, the wedge drive according to the invention thus makes possible a linear horizontal guiding of the slider element with respect to the slider receptacle because of the interaction of its characteristics.

Moreover, the interaction of the characteristics of the wedge drive according to the invention makes possible a simple extremely precise manufacturing of the wedge drive in that a only extremely low clearance, in particular a clearance of less than 2/100 mm, does exist between the slider element and the slider element receptacle in the cross direction while the slider element carries out a working movement. This property of wedge drives according to the invention is substantiated in that the guiding device is stable in the cross direction in that a very low number of components can be used for the guiding device, wherein the components are supported on the slider element and the slider element receptacle by a form-fit, wherein in particular each sliding plate of the sliding plate formation is supported on the slider element or on the slider element receptacle directly by a form fit acting in the cross direction. In conventional wedge drives, slide plate formations have a high number of sliding plates placed the one next to the other in the cross direction. During the manufacturing process of the sliding plates, there are inevitably manufacturing tolerances so that the arrangement of several sliding plates side by side in the cross direction inevitably leads to a clearance that results from the sum of the manufacturing tolerances. For the wedge drive according to the invention, a clearance due to manufacturing tolerances can be avoided at least as far as possible in that the side sliding plates are supported on the second guiding element by a form fit acting in the cross direction and that the central element is placed in the cross direction between the side sliding plates so that, when mounting the wedge drive, the distance in the cross direction between the side sliding plates can be adjusted to the width of the central element in the cross direction by purposefully grinding exactly one sliding plate until the distance between the side sliding plates is very exactly adapted to the width of the central element.

The wedge drive according to the invention is particularly preferably designed in such a manner that the central element bears directly on both side sliding plates so that any additional clearance that could arise due to the insertion of further elements between side sliding plates and the central element is per se avoided. Moreover, manufacturing costs for the production of additional elements can thus be avoided. The guiding device particularly preferably consists of the two side sliding plates and of the central element and in particular of a return stroke section provided on the central element, wherein each of said elements of the guiding device is designed in particular as a one-part element. The preferably provided return stroke section can be designed integrally in one piece with the central element, in particular with the central sliding plate provided as a central element. The sliding plate formation of the guiding device particularly preferably consists of the two side sliding plates and the central sliding plate provided as a central element, since then a particularly precise adjustment of the geometrical dimensions of the side sliding plates and of the central sliding plate is made possible so that a clearance in the cross direction can be further reduced. This being, the guiding device can have in particular the sliding plates of the sliding plate formation as the only sliding plates providing the sliding surfaces necessary for the sliding guiding of the slider element to the slider element receptacle. The fact that the central sliding plate forms a form fit extending in positive and negative direction along the cross direction with the first guiding element can also contribute to provide said advantageous properties of the wedge drive, when providing a central sliding plate as a central element. Such a bidirectionally acting form fit can in particular be implemented without clearance between the first guiding element and the central sliding plate when the central sliding plate is designed in one piece so that the manufacturing tolerance is only due to the production of a single component so that the clearance between the central sliding plate and the first guiding element can be kept particularly low.

In an embodiment, the central element is placed respectively directly on the two side sliding plates with a clearance in the cross direction of less than 0.04 mm, in particular of less than 0.02 mm, in particular of less than 0.01 mm. Thus, a particularly low clearance in the cross direction is ensured between the first guiding element and the second guiding element. In particular, the wedge drive according to the invention can be designed in such a way that the slider element is guided so as to slide over a sliding length along the slider element receptacle in the sliding direction, wherein the slider element has a clearance in the cross direction with respect to the slider element receptacle of less than 0.04 mm, in particular of less than 0.02 mm with respect to the slider element receptacle in any position along the sliding direction within the sliding length. This particularly clearance-free implementation of the guiding device between the slider element receptacle and the slider element can only be implemented because of the design of the wedge drive according to the invention and brings said advantages relating to the ability to perform extremely precise working movements with the aid of a wedge drive according to the invention.

In an embodiment, the guiding device is designed in such a manner that the first guiding element can slide to the second guiding element over a sliding length extending in the sliding direction, wherein the sliding length is at least 0.5 time, in particular between 0.5 and 3 times the extension of the slider element in the cross direction. A robust construction of the wedge drive can thus simultaneously be guaranteed so that the wedge drive is particularly appropriate for absorbing very high pressing forces, and moreover a sufficient sliding length can be guaranteed so that the slider element can carry out a working movement over a sufficiently long distance in the horizontal direction. Particularly preferably, the sliding plate formation has a constant cross-section perpendicularly to the sliding direction at least in one sliding section that extends in the sliding direction and that has at least the sliding length. A particularly regular and very exact linear guiding of the slider element along the slider element receptacle can thus be ensured beyond the whole sliding length.

In an embodiment, a return stroke section is provided on the side of the central element pointing to the second guiding element, return stroke section that has two retaining sections that protrude in the cross direction beyond the central element and that extend in the cross direction in sections along the two side sliding plates. For example, the return stroke section can be designed as a plate fixed separately on the central element. For example, the return stroke section can be designed in one piece with the central element. For example, the central element can be designed as a central sliding plate that has the return stroke section, wherein the retaining sections are spaced from the first guiding element. For the embodiment described, it can particularly effectively be ensured that the slider element is guided by the slider element receptacle during a return stroke since the return stroke section can transmit return stroke forces from the slider element receptacle to the slider element. This being, it should be taken into account that a wedge drive according to the invention is usually used in a pressing tool, wherein the slider element receptacle is connected with a movable press element. Usually, the movable press element carries out a movement in the vertical direction downwards during a working stroke so that the slider element is forced to a linear horizontal working movement because of the vertical relative movement between the slider element receptacle and the driver element. During a return stroke, the movable press element moves vertically in the opposite direction in comparison with the working stroke, i.e. usually vertically upwards. By providing a return stroke section on the central element, it can be particularly effectively ensured that the slider element is forced to a return movement during the return stroke during which the slider element receptacle carries out a relative movement in the vertical direction with respect to the fixed driver element, the return movement running opposite to the working movement. The return stroke section extends respectively with a retaining section in the cross direction in sections along the two side sliding plates, wherein a side sliding plate is placed respectively at least in sections between the first guiding element and the return stroke section. During a working stroke, the side sliding plates exert a working force onto the first guiding element; during a return stroke, a return stroke force is applied between the retaining sections and the side sliding plates.

Particularly preferably, the return stroke section extends from the first guiding element towards the second guiding element beyond the side sliding plates, wherein the retaining sections extend respectively along a section in the cross direction between the side sliding plates and the second guiding element. Each retaining section thus extends over a section in the cross direction with respect to a direction perpendicularly to the cross direction and perpendicularly to the sliding direction between a side sliding plate associated thereto and the second guide element. In this embodiment, the return stroke section can be designed particularly robust, for example the return stroke section can be placed in a recess of the second guiding element that is provided for that purpose. The transmission of a return stroke force between the first and the second guiding element can then take place over the section in the cross direction in which the retaining sections are placed between the side sliding plates and the second guiding element on which the side sliding plates are fixed. Particularly preferably, in said embodiment, the first guiding element is designed as the slider element and the second guiding element as the slider element receptacle. Then, for such a design of the wedge drive, when implementing a low type in particular with reference to the vertical direction, a recess can be provided in the slider element receptacle for the return stroke section, whereas no such recess is necessary in the slider element so that the slider element can be constructed with compact dimensions and provides sufficient space for fixing an additional return stroke spring that supports the return stroke as known for conventional wedge drives.

In an embodiment, each side sliding plate bears at least with two bearing surfaces on the second guiding element. A first bearing surface of each side sliding plate extends in the cross direction and in the sliding direction, wherein each side sliding surface is pressed with its first bearing surface against the second guiding element by fixing means. Furthermore, each side sliding plate has a second bearing surface that extends perpendicularly to the cross direction. Moreover, each of the side sliding plates has at least one sliding plate bearing surface with which it bears on the central element. The sliding plate bearing surface of each side sliding plate extends perpendicularly to the cross direction, wherein the sliding plate bearing surface and the second bearing surface are situated on two opposed sides of the respective side sliding plate that are facing away from each other and wherein the first bearing surface of the side sliding plate extends in particular exclusively in an area that extends in the cross direction between the sliding plate bearing surface and the second bearing surface. With the embodiment described, on the one hand a very reliable force transmission during a working stroke is ensured from the slider element receptacle to the slider element since each of the side gliding plates is pressed against the second guiding element by fixing means over a first bearing surface that extends in the cross direction and in the sliding direction so that, in case of a load of the side sliding plate perpendicularly to the cross direction that occurs during the proper use of the wedge drive during a working stroke, a relative movement between the second guiding element and the side sliding plates can be reliably avoided. Particularly preferably, the side sliding plates have a second sliding plate bearing surface each that extends parallel to the first bearing surface, wherein the press force is transmitted during a working stroke onto the slider element by the second sliding plate bearing surface and during the working movement the slider element on the second sliding plate bearing surface is transmitted to the slider element and during the working movement the slider element slides along the sliding plate bearing surface by bearing thereon. Moreover, by providing a second bearing surface and a sliding plate bearing surface on each side sliding plate that extend respectively in the transverse cross direction and that ensure on the one hand a contact of the side sliding plate with the central element and on the other hand a contact of the side sliding plate with the second guiding element, it is ensured that the side sliding plate is guided between the central element and the second guiding element in the cross direction so that a clearance in the guiding device in the cross direction is prevented during a working stroke. In particular, each side sliding plate can bear with its second bearing surface on the step of the second guiding element. The guiding property of the guiding device by means of the bearing surfaces and the sliding plate bearing surface that comprises a side sliding plate and by which a contact with the second guiding element and the central element is ensured, the side sliding plate resting on the second guiding element and on the central element, can be particularly advantageous. In general, it should be noted here that it should always be understood in this specification by the expression “bearing of two elements” that the two elements are maximally spaced from each other by 0.01 mm. Particularly preferably, the first bearing surface of each side sliding plate is bigger than the second bearing surface and bigger than the sliding plate bearing surface. A force that is transmitted during the working stroke by the side sliding plate can be transmitted to the first guiding element in a particular reliable and uniform way by the consequently very big first bearing surface. The second bearing surface and the sliding plate bearing surface provide a guiding of the two guiding elements to each other in the cross direction. To this purpose, it was necessary to provide large surfaces; however, it is sufficient to provide in particular one contact surface, i.e. the second bearing surface and the sliding plate bearing surface that is smaller than the contact surface to be provided, i.e. the first bearing surface, for transmitting the force arising during the working stroke.

Particularly preferably, the first bearing surface is spanned across a plane that is spanned across the cross direction and the sliding direction. Particularly preferably, the second bearing surface and the sliding plate bearing surface are respectively spanned across a plane that is spanned across the transverse cross direction and the sliding direction. A particularly reliable transmission of force during a working stroke and a particularly reliable guiding perpendicularly to the cross direction is ensured by an appropriate plane configuration of the bearing surfaces and of the sliding plate bearing surfaces.

In an embodiment, each side sliding plate has a third bearing surface with which it bears on the second guiding element, wherein the third bearing surface extends from the second bearing surface in the cross direction away from the first bearing surface. A further improved guiding of the side sliding plate with respect to the second guiding element can thus be ensured and thus a further improved fixing of the side sliding plate on the second guiding element. Particularly preferably, the step on which the side sliding plate associated thereto bears extends between the first and the third bearing surface, wherein the second bearing surface bears on the surface of the step that forms the height difference of the step. The surface that forms the height difference of the step naturally extends in the transverse cross direction and is particularly preferably designed as a plane that is spanned across the transverse cross direction and the sliding direction. Particularly preferably, the third bearing surface is spanned across a plane that is spanned across the cross direction and across the sliding direction so that a particularly stable bearing and thus fixing of the side sliding plate on the second guiding element can be ensured.

Each side sliding plate preferably has a return stroke bearing surface that extends in the cross direction between the sliding plate bearing surface and the first bearing surface. A return stroke section provided on the central element can bear on the return stroke bearing surface, return stroke section by which a force arising during the return stroke can be transmitted. Particularly preferably, the return stroke bearing surface is spanned across a plane that is spanned across the cross direction and the sliding direction. Particularly preferably, the return stroke bearing surface is smaller than the first bearing surface since only the force arising during a return stroke is transmitted by the return stroke surface, this force being significantly smaller than the force to be transmitted by the first bearing surface that arises during the working stroke. Due to the preferred embodiment, a particularly small size of the wedge drive can be ensured to which in particular the providing of a smallest possible return stroke bearing surface can contribute. It should be noted here that, for implementing wedge drives, to keep small sizes constitutes a particularly desirable aim that is traditionally difficult to reach because of the necessarily very robust configuration of a wedge drive.

In an embodiment, the central element is designed as a central sliding plate and is fixed to the first guiding element, wherein the first guiding element has a stepped surface shape along the cross direction on its surface facing the central sliding plate. A stepped surface shape along the cross direction means that, in a cross-sectional view perpendicularly to the sliding direction the surface shape has a stepped extent depending on the cross direction. There are thus, depending on the cross direction, step offsets in a direction that extends perpendicularly to the cross direction and perpendicularly to the sliding direction. The central sliding plate has on its surface pointing to the first guiding element a surface shape corresponding to the stepped surface shape of the first guiding element, wherein a form fit between the first guiding element and the central sliding plate that acts in the cross direction is ensured by the surface shapes corresponding to each other. This being, the central sliding plate is with its stepped surface shape at least in sections in contact with the stepped surface shape of the first guiding element. This being, the corresponding surface shapes are designed in such a way that they provide a bidirectional form fit along the cross direction between the central sliding plate and the first guiding element. This means that the form fit impedes a movement of the central sliding plate in the cross direction with respect to the first guiding element in case of a force applied onto the central sliding plate along the cross direction in a positive direction as well as for a force applied onto the central sliding plate along the cross direction in a negative direction.

In an embodiment, the stepped surface shape of the first guiding element is formed at least partially, in particular entirely, by three fixing surfaces of the guiding element. A first fixing surface is placed in the cross direction between a second and a third fixing surface. The first fixing surface is spanned across a plane that is spanned across the cross direction and across the sliding direction. The second and the third fixing surface are spanned respectively across a plane that is spanned across the transverse cross direction and across the sliding direction. With this preferred embodiment, a guiding of the central sliding plate in the cross direction is ensured in two directions by the second and the third fixing surface since a contact between the central sliding plate and the first guiding element can be ensured by the shape of the second and of the third fixing surface and the first fixing surface placed between them that again extends in the cross direction and in the sliding direction, contact for which the central sliding plate bears respectively on the second and/or on the third fixing surface in case a force is applied in positive as well as in negative direction along the cross direction so that a movement of the central sliding plate along the cross direction is avoided. In the described embodiment, it is particularly preferably provided that the second and the third fixing surface extend from the first fixing surface to the second guiding element, wherein the central sliding plate is placed between the second and the third fixing surface and wherein the central sliding plate bears on the three fixing surfaces with their corresponding surface shape and is pressed against the first fixing surface by fixing means. In this embodiment, the three fixing surfaces thus form a recess in which a section of the central sliding plate is placed. The described embodiment can thus have a particularly robust design and can be easily produced since, due to the provided corresponding recess in the massive second guiding element, the central sliding plate can be inserted into this recess with its corresponding surface shape without delicate machining operations of the central sliding plate or of the first guiding element being necessary. While the central sliding plate is pressed by fixing means against the first fixing surface, it can furthermore be ensured that the central sliding plate is reliably maintained in the recess formed by the three fixing surfaces, which further improves the guiding properties of the guiding devices. Particularly preferably, the surface of the first fixing surface is at least twice as large as the common surface of the second and of the third fixing surface so that the fact that a higher force is to be transmitted by the first fixing surface than by the second and the third fixing surfaces can be taken into account. Consequently, a particularly robust wedge drive with the smallest size can herewith be implemented.

Particularly preferably, the sliding plate formation consists of the two side sliding plates and of the central sliding plate. On the one hand, the clearance of the guiding device can thus be reduced to a minimum since only a few components are provided for implementing the guiding device, clearance for which manufacturing tolerances are to be taken into account. Moreover, the manufacturing costs can thus be kept particularly low. In particular, the guiding device that linearly guides the slider element to the slider element receptacle can consist of the sliding plate formation.

In an embodiment, all the surfaces by which the first guiding element and the second guiding element are in contact with the sliding plates of the sliding plate formation and in particular also the sliding plates with each other are designed for guiding the slider element to the slider element receptacle as even surfaces that extend either perpendicularly to the cross direction or perpendicularly to the transverse cross direction. By providing surfaces that are exclusively perpendicular to each other by which the two guiding elements are respectively in contact with the sliding plates, the manufacturing of the wedge drive can be particularly simplified since reasonably priced manufacturing tools can thus be used for implementing the wedge drive, for example a triaxial milling machine. Such particularly cheap manufacturing tools do not allow for realizing surfaces that are obliquely standing to each other but it is possible to implement a design of the components in such a manner that they have only limiting surfaces that extend either perpendicularly to the cross direction or perpendicularly to the transverse cross direction. With the described embodiment, due to the fact that all the surfaces by which the first guiding element and the second guiding element are in contact with the sliding plates of the sliding plate formation, a guiding with respect to the vertical press force is ensured as well as a guiding with respect to the force arising during the working movement of the slider element in the cross direction. In particular, the common surface of the surfaces that extend perpendicularly to the transverse cross direction can be bigger than the common surface of the surfaces that extend perpendicularly to the cross direction. It can thus be taken into account that the force causing the working movement that arises with a working stroke is bigger than the force acting during the working movement along the cross direction. In particular, the common surface of the surfaces that extend perpendicularly to the transverse cross direction can be at least twice bigger than the common surface of the surfaces that extend perpendicularly to the cross direction.

In general, it can be advantageous that the slider element is designed as the first guiding element and the slider element receptacle as the second guiding element. A particularly small size can then be realized and the side sliding plates that surround the central element can ensure a transmission of force from the slider element receptacle to the slider element that is particularly uniform.

In an embodiment, the side sliding plates differ in their length of extension in a direction that is perpendicular to the sliding direction and perpendicular to the cross direction, i.e. in the transverse cross direction, by less than 0.01 mm, wherein this length of extension is at least 10 mm. Such an ideally identical configuration of the side sliding plates with reference to their length of extension in the transverse cross direction can ensure a particularly clearance-free guiding device. Such an extremely precise identical design of the side sliding plates can be realized in that said lengths of extension of the two side sliding plates are adjusted in a single process step for which the two side sliding plates are adjusted by exactly one tool, such as for example, a miller, to the desired length of extension.

Particularly preferably, the side sliding plates bear respectively on the first guiding element, the central element and on the second guiding element, wherein the central element bears on the first guiding element and on the side sliding plates and in particular on the second guiding element. The guiding property of the guiding device can be particularly advantageous with the contact ensured by the close fit. In an embodiment, the central element is spaced from the second guiding element. This embodiment can be particularly easily implemented since then the extension of the central element in the transverse cross direction does not need to be extremely exactly adjusted. In an embodiment, the central element also bears on the second guiding element. With this embodiment, a particularly reliable transmission of force is ensured during the working stroke.

In an embodiment, slider sliding plates are provided on the slider element and driver sliding plates on the driver element, wherein the slider sliding plates and the driver sliding plates form a driver guiding for the linear guiding of the slider element along the driver element in a driver sliding direction, wherein the driver sliding direction extends in a plane that is perpendicular to the cross direction, wherein the driver sliding direction forms an angle of at least 20°, in particular between 30° and 120° with the sliding direction. By providing slider sliding plates on the slider element on its side facing the driver element and by providing driver sliding plates on the driver element on its side facing the slider element, a driver guiding can be ensured by which the linear guiding provided by the guiding device can be further assisted. The fact that the driver sliding direction extends in a plane that is perpendicular to the cross direction contributes particularly thereto, wherein in particular the sliding direction is also in this plane. The fact that a corresponding angle is provided between the driver sliding direction and the sliding direction ensures the conversion of a vertical press force generated by a vertical press movement into a horizontal working movement.

Furthermore, this invention relates to a method for manufacturing a wedge drive, wherein a thickness of the two side sliding plates that the length of extension of the side sliding plates defines in a direction that is perpendicular to the sliding direction and perpendicular to the cross direction, when the side sliding plates are mounted in the wedge drive, is simultaneously and jointly adjusted by a tool. Particularly preferably, the width of exactly one of the side sliding plates that the length of extension of these side sliding plates defines along the cross direction when this side sliding plate is mounted in the wedge drive is adjusted by taking into account the distance between the steps of the second guiding element in the cross direction and the length of extension of the central element and of the other side sliding plate in the cross direction. Due to the simultaneous adjusting of the thicknesses of the side sliding plates, a particularly uniform linear guiding of the slider element during a working stroke can be ensured. Then, due to the simultaneous adjusting of the thickness of the two side sliding plates, it can be ensured that no height difference in the transverse cross direction occurs in the guiding device along and between the side sliding plates, which is the condition for realizing a uniform linear guiding. Due to the adjusting of the width of exactly one of the two side sliding plates depending on the distance between the steps and the length of extension of the central element and of the other side sliding plate, the implementation of the wedge drive can be carried out in that finished components, in particular the slider element, the slider element receptacle, the central element and the other side sliding plate are measured in their dimensions in the cross direction and then the width of the specific side sliding plate is purposefully adapted to these dimensions. A particularly good guiding along the cross direction by the guiding device can thus be ensured.

The invention shall be explained below in more detail with reference to four figures.

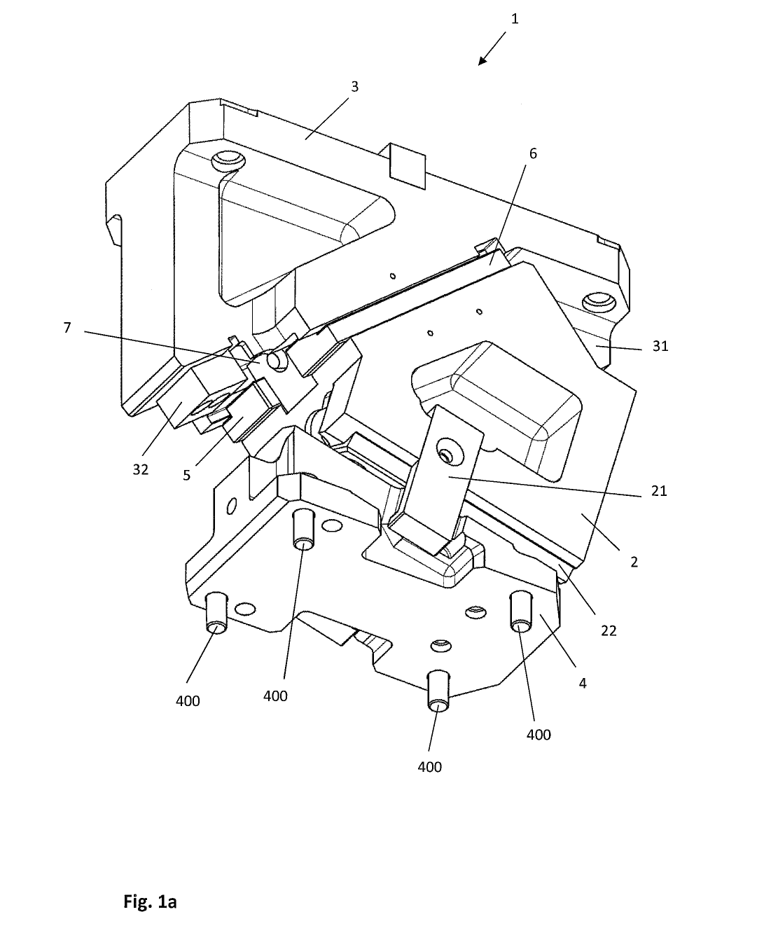

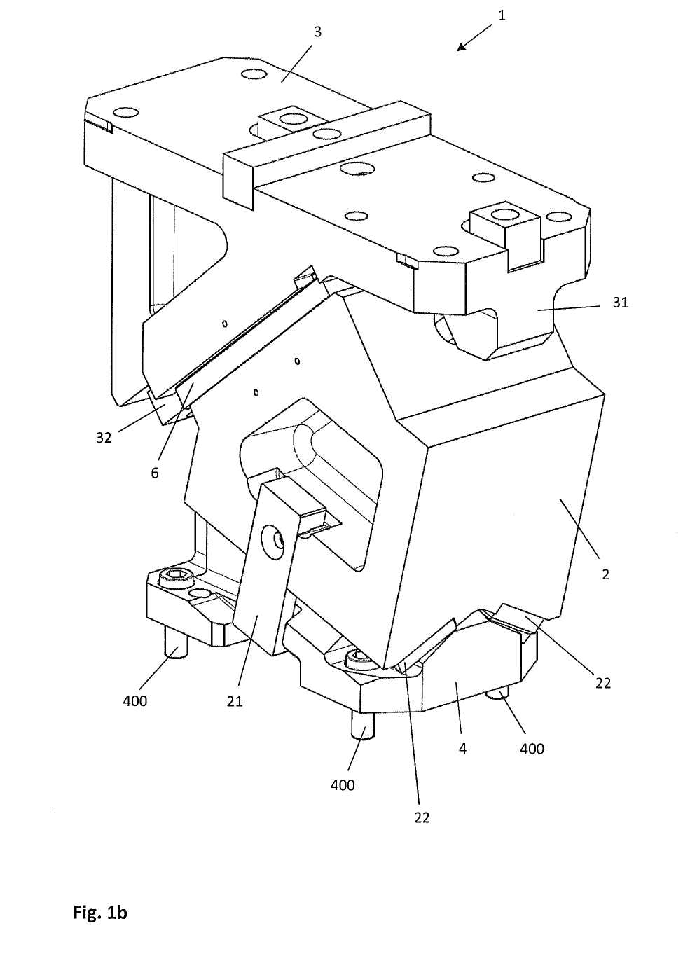

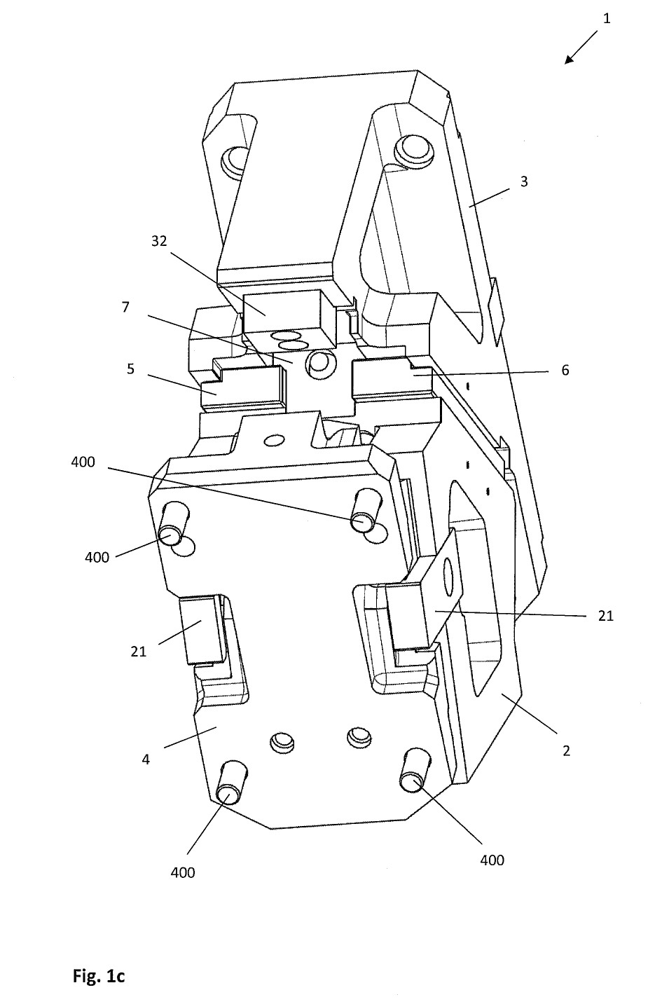

FIG. 1 shows schematic views from different angles of an embodiment of a wedge drive according to the invention in different schematic diagrams.

FIG. 2 shows a schematic view of a first component of the embodiment according to FIG. 1 in a schematic diagram.

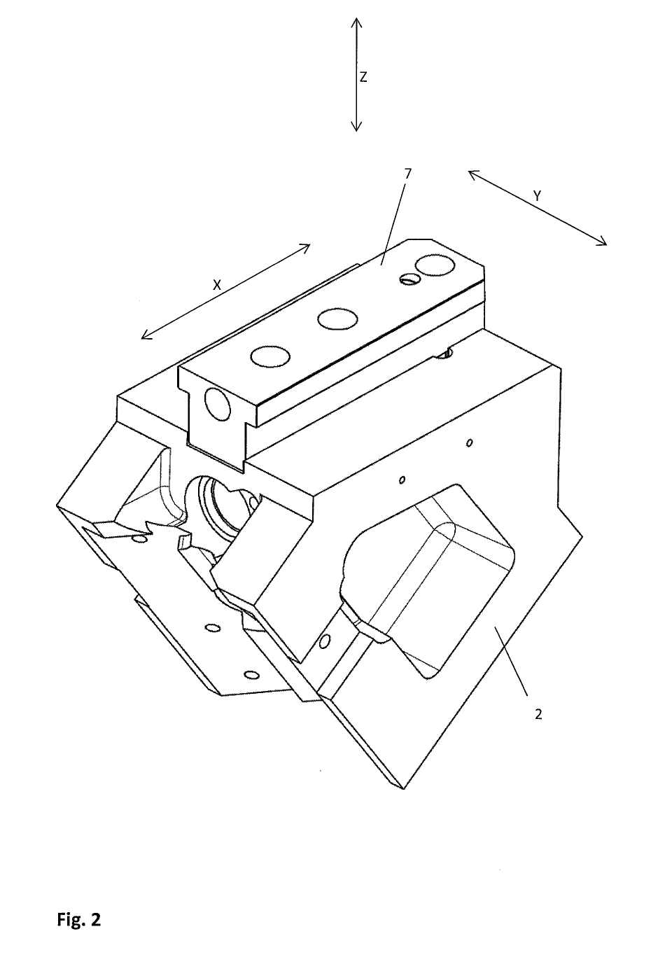

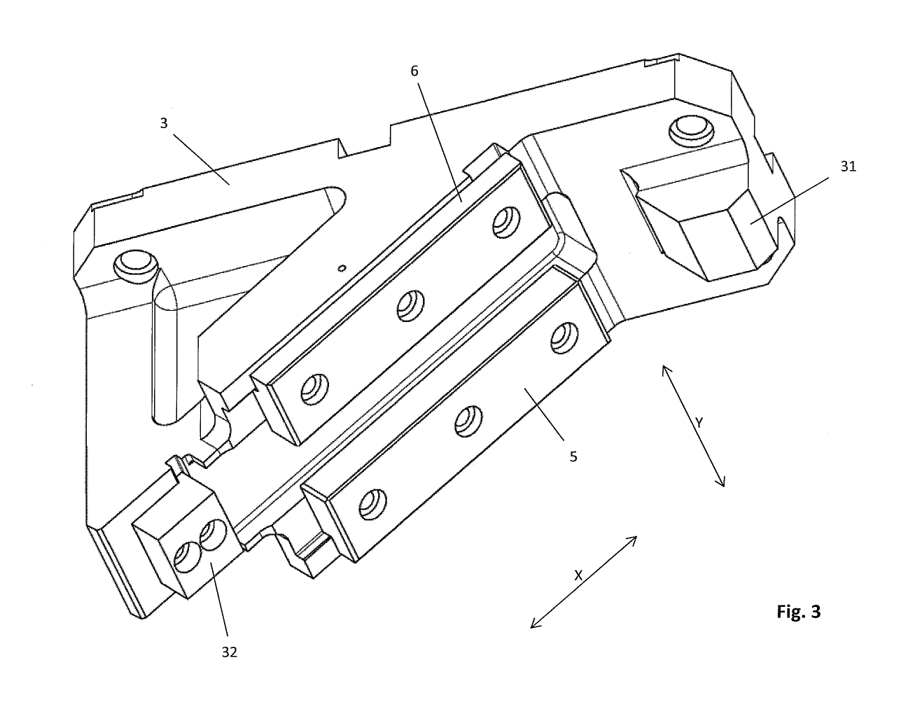

FIG. 3 shows a schematic view of a further component of the embodiment according to FIG. 1 in a schematic diagram.

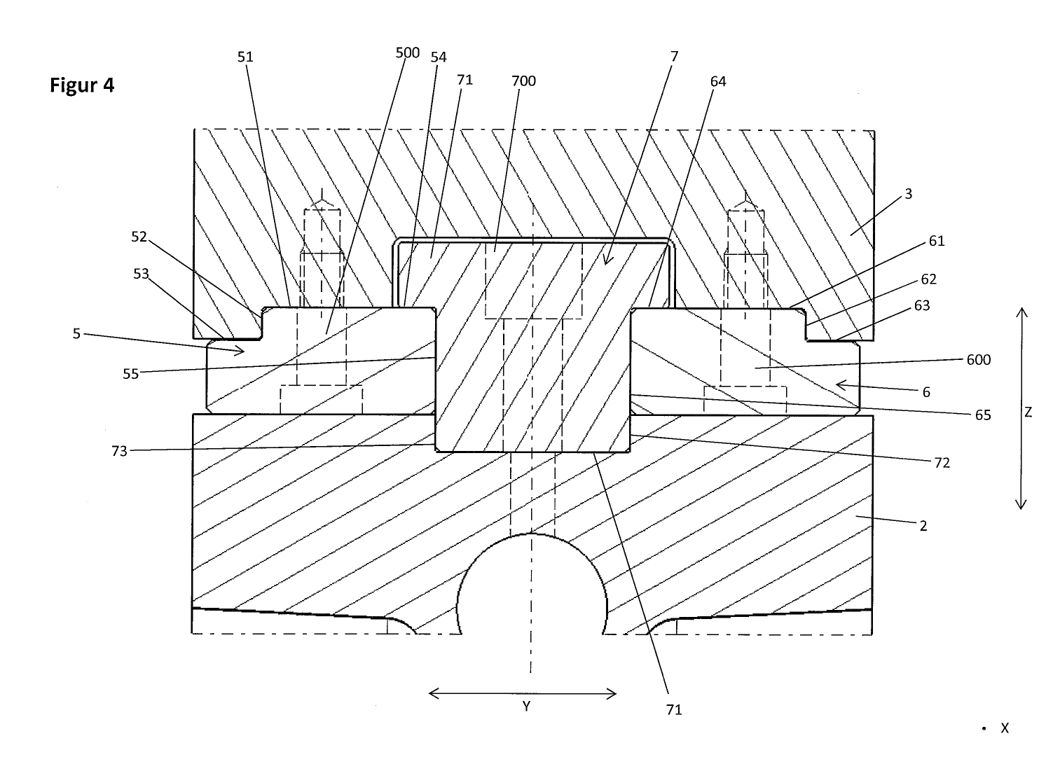

FIG. 4 shows a section of the cross-section of the embodiment according to FIG. 1 perpendicularly to the sliding direction in a schematic diagram.

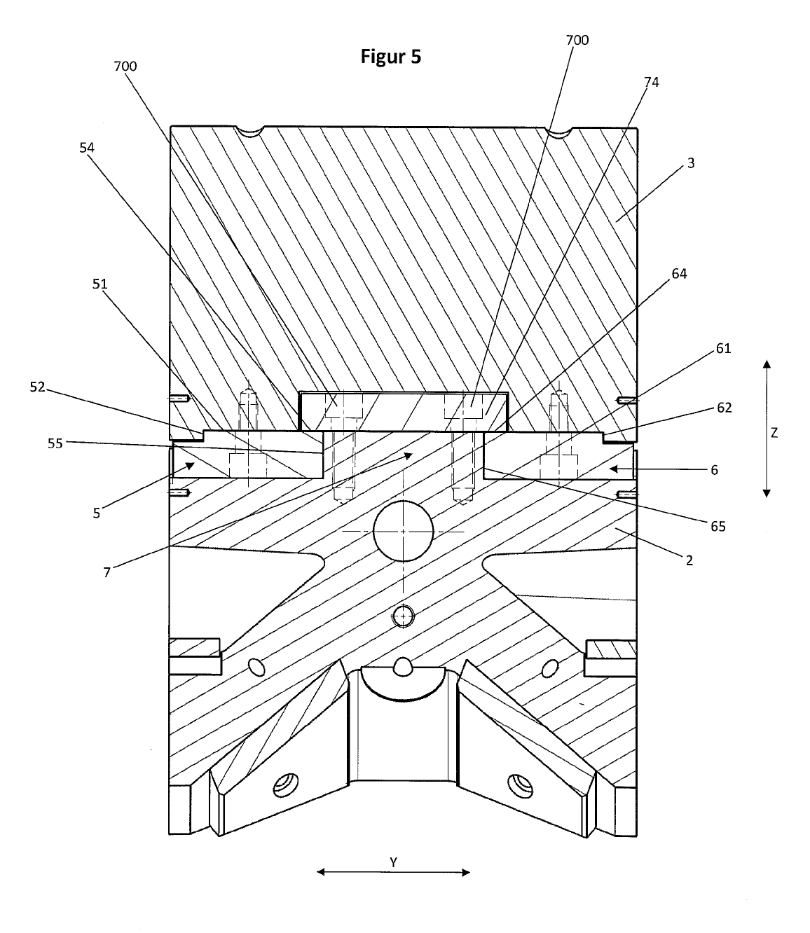

FIG. 5 shows a section of the cross-section perpendicularly to the sliding direction of a further embodiment in a schematic diagram.

An embodiment of a wedge drive 1 according to the invention is schematically represented in FIG. 1 that comprises the FIGS. 1a, 1b and 1c in different schematic diagrams from different angles. It can be seen in FIG. 1 that a wedge drive according to the invention comprises a slider element 2 that is placed vertically between a slider element receptacle 3 and a driver element 4. A guiding device that, in this case, comprises a sliding plate formation that consists of three sliding plates, namely a central sliding plate 7 and two side sliding plates 5, 6, connects the slider element 2 with the slider element receptacle 3. Moreover, the slider element 2 is connected with the driver element 4 by a driver guiding that comprises the slider sliding plates 22 that are placed on the side of the slider element 2 that is facing the driver element 4. Moreover, the slider element 2 is connected with the driver element 4 by a return stroke device 21 that ensures that the slider element 2 remains connected with the driver element 4 even during a return stroke during which the slider element receptacle 3 is moved vertically away from the driver element 4.

The basic structure of a wedge drive 1 according to the invention can thus clearly be seen in FIG. 1. The driver element 4 is fixed by fixing means, in this case fixing screws 400, to a bottom element of a pressing tool. The slider element receptacle 3 has in FIG. 1 visible feedthroughs by which it can be fixed to a movable press element of the pressing tool by means of fixing means such as, for example, screws. During operation, the movable pressing element moves during a working stroke vertically with respect to the bottom element to which the driver element 4 is fixed. During a working stroke, the movable press element moves towards the bottom element, i.e. towards the driver element 4 while, during a return stroke, it moves vertically away from the bottom element, i.e. from the driver element 4.

It can be seen in FIG. 1 that the guiding device between the slider element 2 and the slider element receptacle 3 ensures a linear guiding of the slider element 2 along the slider element receptacle 3 along a sliding direction X that forms an angle of approx. 30° to the vertical direction. The driver guiding ensures a linear guiding of the slider element 2 along the driver element 4 along a driver sliding direction that forms an angle of approx. 80° to the vertical direction. The driver sliding direction and the sliding direction X form an angle of approx. 50° to each other. It results from this constructive assembly of the wedge drive 1 that can be seen in FIG. 1 that the slider element 2 carries out a horizontal linear working movement between the slider element receptacle 3 and the driver element 4 when the slider element receptacle 3 is moved vertically towards the driver element 4. The return stroke device 21 simultaneously ensures that the slider element 2 carries out a horizontal linear return movement between the slider element receptacle 3 and the driver element 4 during a return stroke, i.e. when the slider element receptacle 3 is moved vertically away from the driver element 4, this return movement constituting the negative reproduction of the linear working movement during a working stroke. This being, the return stroke device 21 is firmly fixed to the slider element 2 and engages corresponding sliding protrusions that are placed on the driver element 4 so that the slider element 2 always remains connected with the driver element 4 during a return stroke. The embodiment of a wedge drive 1 according to the invention that is represented in FIG. 1 further comprises a first supporting element 31 and a second supporting element 32 that are firmly fixed to the slider element receptacle 3. The second supporting element 32 limits the return movement of the slider element 2 during a return stroke since the second supporting element 32 provides a limit stop for the central sliding plate 7 that is fixed to the slider element 2. The first supporting element 31 serves for the support of a return spring, for example a gas pressure spring. Such a return spring is supported on the first supporting element 31 and is compressed during a working stroke and contributes to the fact that the slider element 2 moves back during a return stroke to its starting position in which it bears on the second supporting element 32 with the central sliding plate 7 fixed thereto.

When examining FIGS. 1, 2, 3 and 4 together, the structure and the function of the guiding device of the represented embodiments of the wedge drive 1 according to the invention become particularly clear. The guiding device comprises a sliding plate formation that consists of the central sliding plate 7 and of the two side sliding plates 5, 5. The two side sliding plates 5, 6 are fixed to the slider element receptacle 3 that acts as second guiding element, whereas the central sliding plate 7 is fixed to the slider element 2 that acts as first guiding element. In the embodiment described, the central sliding plate 7 of the sliding plate formation thus forms the central element 7. It can be fundamentally seen in the figures that all the surfaces by which the slider element 2 and the slider element receptacle 3 are in contact with the sliding plates 5, 6, 7 and the sliding plates 5, 6 with each other are spanned across planes, i.e. are designed as even surfaces that extend either perpendicularly to the cross direction Y or perpendicularly to the transverse cross direction Z. This being, the transverse cross direction Z is defined in that it extends perpendicularly to the cross direction Y and perpendicularly to the sliding direction X.

The fixing of the central sliding plate 7 to the slider element 2 can be seen particularly clearly when examining FIGS. 2 and 4 together. The slider element 2 has a stepped surface shape that is formed by three fixing surfaces 71, 72, 73. The first fixing surface 71 is situated in the cross direction between the second and the third fixing surfaces 72, 73. The first fixing surface 72 is spanned across a plane that is spanned across the cross direction Y and the sliding direction X. The second and the third fixing surfaces 72, 73 are spanned respectively across the transverse cross direction Z and across the sliding direction X and are also even. The central sliding plate has a surface shape that corresponds to the stepped surface shape of the slider element 2 while the central sliding plate 7 has, on its side facing the slider element 2, a cross-section perpendicularly to the sliding direction X that represents the section of a rectangle. The central sliding plate 7 can thus be inserted into the recess in the slider element 2 that is formed by the three fixing surfaces. This being, the dimensions in the cross direction of the central sliding plate 7 are such that it bears with its whole surface on all the three fixing surfaces. Moreover, the central sliding plate 7 is connected with the slider element 2 by screws that extend through feedthroughs in the central sliding plate 7 that are represented in FIG. 2. A corresponding screw is indicated in FIG. 4. The central sliding plate 7 is pressed against the first fixing surface 71 of the slider element 2 by these screws. A very resilient and rigid connection between the central sliding plate 7 and the slider element 2 is ensured by the combined effect of the pressing force exerted by the screws 700 onto the central sliding plate 7 towards the slider element 2 and the firm fixing in the cross direction Y of the central sliding plate 7 by the stepped surface shape that is formed by the three fixing surfaces 71, 72, 73.

The fixing of the side sliding plates 5, 6 on the slider element receptacle 3 can be seen particularly clearly when examining the FIGS. 3 and 4 together. The slider element receptacle 3 has two steps spaced from each other in the cross direction Y, wherein each of the side sliding plates 5, 6 bears on respectively one of the two steps. This being, each of the side sliding plates 5, 6 bears with a first bearing surface 51, 61, a second bearing surface 52, 62 and a third bearing surface 52, 62 on the slider element receptacle 3. The second bearing surface 52, 62 of the side sliding plates 5, 5 is respectively spanned across a plane that is spanned across the sliding direction X and the transverse cross direction Z and bears on the surface of the slider element receptacle 3 that forms the height difference of the respective step. The side sliding plates 5, 5 are pressed with their first bearing surface 51, 61 and their third bearing surface 53, 63 against the slider element receptacle respectively by a screw 500, 600. Due to the fact that the side sliding plates 5, 6 are pressed against the slider element receptacle 3 with their first and third bearing surfaces 51, 61, 53, 63 by the screws 500, 600 and simultaneously bear with their second bearing surfaces 52, 62 on the surface of the slider element receptacle 3 that forms the height difference of the step, which surface is also even and is spanned across the transverse cross direction Z across the sliding direction X, the sliding plates 5, 6 are so firmly fixed to the slider element receptacle 3 that a relative movement of the sliding plates 5, 6 along the cross direction Y relative to the slider element receptacle 3 is optimally avoided.

The single elements of the embodiment of the wedge drive 1 according to the invention are, as can be seen in particular in FIG. 4, adapted to each other in such a way that the central sliding plate 7 directly bears on the sliding plate bearing surfaces 55, 65 of the side sliding plates 5, 6 that surround it in the cross direction. In case of a sliding of the slider element 2 along the slider element receptacle 3 along the sliding direction X that extends for the cross-section according to FIG. 4 perpendicularly to the drawing layer, the central sliding plate 7 slides along the sliding plate bearing surfaces 55, 65 of the two side sliding plates 5. 6. Due to the fact that the central sliding plate 7 bears with its two opposite sides in the cross direction on the two side sliding plates 5, 6 and that moreover the side sliding plates have a sliding plate bearing surface 55, 65 respectively on one side in the cross direction and a second bearing surface 52, 62 on their opposite side in the cross direction, the central sliding plate 7 is thus firmly guided between the side sliding plates 5, 6 without the central sliding plate 7 being able to appreciably move in the cross direction Y relative to the slider element receptacle 3. Since furthermore the central sliding plate 7 is connected along the cross direction Y in two directions with a form fit with the slider element 2 and is fixed, as explained for the slider element 2, the described embodiment according to the invention thus ensures a linear guiding of the slider element 2 along the sliding direction X on the slider element receptacle 3 without the slider element 2 carrying out a movement with respect to the slider element receptacle 3 along the cross direction Y.

The return stroke section 74 of the central sliding plate 7 can be seen in particular when examining FIGS. 1 and 4 together. The return stroke section 74 has two retaining sections that extend respectively in the cross direction over a section along the two side sliding plates 5, 6, wherein they are placed in this section along the cross direction with respect to the transverse cross direction Z between the slider element receptacle 3 and the respective side sliding plates 5, 6. The side sliding plates 5, 6 thus bear with a return stroke bearing surface 54, 64 respectively on a retaining section of the return stroke section of the central sliding plate 7. It is herewith ensured that, in case of a return stroke during which the slider element receptacle 3 is moved vertically upwards away from the driver element 4, the slider element receptacle 3 is also impinged with a force acting in vertical direction upwards over the contact between the central sliding plate 7 and side sliding plates 5, 6 over the retaining sections and the return stroke bearing surfaces 54, 64 so that the slider element 2 is forced back to its starting position in which the central sliding plate 7 bears on the second supporting element 32.

The cross-section perpendicularly to the sliding direction X of a further embodiment of a wedge drive 1 according to the invention is schematically represented in FIG. 5. An essential difference between the embodiment according to FIG. 5 and the embodiment represented in FIGS. 1 to 4 consists in that the central element 7 is formed in one piece with the slider element 2, i.e. that the slider element 2 and the central element 7 are designed as an integrally manufactured component, in this case as a cast metal body. As explained for the embodiment according to FIGS. 1 to 4, for the embodiment according to FIG. 5 a stable linear guiding of the slider element 2 is also ensured along the sliding direction X on the slider element receptacle 3, wherein the central element 7 is placed in the cross direction Y between the two side sliding plates 5, 6, wherein the side sliding plates 5, 6 bear respectively with their sliding plate bearing surfaces 55, 65 on the central element 7 with an extremely low clearance of less than 0.02 mm. As for the embodiment according to FIGS. 1 to 4, for the embodiment according to FIG. 5, the pressing force arising during a working stroke is also transmitted by the slider element receptacle 3 onto the slider element 2 by the side sliding plates 5, 6. This being, this force transmission takes place over the first bearing surfaces 51, 61 from the slider element receptacle to the side sliding plates 5, 6 and then from the side sliding plates 5, 6 to the slider element 2 over two sliding plate bearing surfaces that extend parallel to the first bearing surfaces 51, 61 and that are placed, with respect to the transverse cross direction Z, at the ends of the side sliding plates 5,6 that are opposed to the first bearing surfaces 51, 61. A problematic force for the linearity of the guiding between the slider element 2 and the slider element receptacle 3 along the transverse cross direction Y is absorbed by the guiding device of the embodiment according to FIG. 5, while the side sliding plates 5, 6 guide the central element 7 over their sliding plate bearing surfaces 55, 65 and are themselves form fitted in the transverse cross direction Y to the slider element receptacle 3 with their second bearing surfaces 52, 62 on the steps of the slider element receptacle 3.

Furthermore, a return stroke section 74 designed as a separate component is provided in the embodiment according to FIG. 5. This return stroke section 74 is firmly fixed to the central element 7 by screws 700 and has two retaining sections that extend respectively with a section along the transverse cross direction Y along one of the two side sliding plates 5, 6. As explained for the embodiment according to FIGS. 1 to 4, due to the arrangement of the return stroke section 74 on the central element 7 with its relative position to the side sliding plates 5, 6, it is ensured that, in case of a return stroke taking place after a working stroke, the slider element 2 is forced back into its starting position before the working stroke is carried out, starting position in which, in a not represented embodiment, the central element 7 bears on the second supporting element 32 as explained above. In the embodiment represented in FIG. 5, the return stroke section 74 is designed as an independent sliding plate, the surface of which is designed in such a way that a very small friction force exists during the return stroke with which the return stroke section 74 slides in sections along the side sliding plates 5, 6. In the described embodiment, the return stroke section 74 is designed as a sliding plate made of bronze.

### LIST OF REFERENCE NUMERALS

1 Wedge drive
2 Slider element
3 Slider element receptacle
4 Driver element
5 Side sliding plate
6 Side sliding plate
7 Central sliding plate
21 Return stroke device
22 Slider sliding plates
31 First supporting element
32 Second supporting element
51, 61 First bearing surface
52, 62 Second bearing surface
53, 63 Third bearing surface
54, 64 Return stroke bearing surface
55, 65 Sliding plate bearing surface
71 First fixing surface
72 Second fixing surface
73 Third fixing surface
74 Return stroke section
400 Fixing screw
500 Screw
600 Screw
700 Screw

1. Wedge drive for converting a vertical press force into a horizontal linear working movement, the wedge drive comprising a slider element, a driver element and a slider element receptacle, wherein the slider element is placed vertically between the driver element and the slider element receptacle, wherein the slider element and the slider element receptacle are designed as two guiding elements on which a sliding plate formation is placed, wherein the sliding plate formation is surrounded by a guiding device that is designed for the linear guiding of the slider element along the slider element receptacle in a sliding direction (X), wherein the guiding device comprises a central element that is provided on a first of the two guiding elements on its side pointing to a second of the two guiding elements, wherein the sliding plate formation comprises at least two side sliding plates that are fixed to a second of the two guiding elements and that are spaced from each other in a cross direction (Y) that is perpendicular to the sliding direction (X), wherein the central element is placed in the cross direction between the side sliding plates, wherein the second guiding element has two steps spaced from each other in the cross direction (Y), wherein each of the two side sliding plates closely fits to respectively one of the two steps with a form fit acting in the cross direction (Y).

2. Wedge drive according to claim 1, characterized in that the central element is placed directly on the two side sliding plates with a clearance in the cross direction (Y) of less than 0.04 mm, in particular of less than 0.02 mm.

3. Wedge drive according to claim 1, characterized in that the guiding device is designed in such a manner that the first guiding element can slide to the second guiding element over a sliding length extending in the sliding direction (X), wherein the sliding length is at least 0.5 time, in particular between 0.5 and 3 times the extension of the slider element in the cross direction (Y), wherein in particular the sliding plate formation has a constant cross-section perpendicularly to the sliding direction at least in one sliding section that extends in the sliding direction (X) and that has at least the sliding length.

4. Wedge drive according to claim 1, characterized in that a return stroke section is provided on the side of the central element that points to the second guiding element, this return stroke section having two retaining sections that protrude in the cross direction (Y) beyond the central element and that extend in the cross direction (Y) in sections along the two side sliding plates.

5. Wedge drive according to claim 4, characterized in that the return stroke section extends from the first guiding element towards the second guiding element beyond the side sliding plates, wherein the retaining sections extend respectively along a section in the cross direction (Y) between the side sliding plates and the second guiding element.

6. Wedge drive according to claim 1, characterized in that each side sliding plate bears at least with two bearing surfaces on the second guiding element, wherein a first bearing surface extends in the cross direction (Y) and the side sliding surface is pressed with its first bearing surface against the second guiding element by one or more fasteners and wherein a second bearing surface extends perpendicularly to the cross direction, wherein each side sliding plate bears with at least one sliding plate bearing surface on the central element, wherein the sliding plate bearing surface extends perpendicularly to the cross direction (Y), wherein the sliding plate bearing surface and the second bearing surface are situated on two opposed sides of the respective side sliding plate that are facing away from each other and wherein the first bearing surface of the respective side sliding plate extends in an area that extends in the cross direction between the sliding plate bearing surface and the second bearing surface.

7. Wedge drive according to claim 6, characterized in that the first bearing surface is spanned across a plane that is spanned across the cross direction (Y) and the sliding direction (X) and that the second bearing surface and the sliding plate bearing surface are respectively spanned across a plane that is spanned across the transverse cross direction (Z) and the sliding direction (X).

8. Wedge drive according to claim 1, characterized in that each side sliding plate has a third bearing surface with which it bears on the second guiding element, wherein the third bearing surface extends from the second bearing surface in the cross direction away from the first bearing surface, wherein in particular the third bearing surface is spanned across a plane that is spanned across the cross direction (Y) and across the sliding direction (X).

9. Wedge drive according to claim 1, characterized in that each side sliding plate has a return stroke bearing surface that extends in the cross direction (Y) between the sliding plate bearing surface and the first bearing surface and that is spanned across a plane that is spanned across the cross direction (Y) and the sliding direction (X), wherein the return stroke bearing surface is smaller than the first bearing surface.

10. Wedge drive according to claim 1, characterized in that the central element is designed as a central sliding plate that is surrounded by the sliding plate formation, wherein the first guiding element has stepped surface shape along the cross direction (Y) on its surface facing the central sliding plate and the central sliding plate has on its surface pointing to the first guiding element a surface shape corresponding to the stepped surface shape, wherein a form fit between the first guiding element and the central sliding plate that acts in the cross direction (Y) is ensured by the surface shapes corresponding to each other.

11. Wedge drive according to claim 10, characterized in that the stepped surface shape of the first guiding element is formed at least partially by three fixing surfaces of the guiding element, wherein a first fixing surface is placed in the cross direction (Y) between a second and a third fixing surface, wherein the first fixing surface is spanned across a plane that is spanned across the cross direction (Y) and across the sliding direction (X) and wherein the second and the third fixing surface are spanned respectively across a plane that is spanned across the transverse cross direction (Z) and across the sliding direction (X), wherein in particular the second and the third fixing surface extend from the first fixing surface to the second guiding element, wherein the central sliding plate is placed between the second and the third fixing surface and wherein the central sliding plate bears on the three fixing surfaces with their corresponding surface shape and is pressed against the first fixing surface by one or more fasteners.

12. Wedge drive according to claim 1, characterized in that the guiding device consists of the central element and the two side sliding plates and in particular of a return stroke section designed as a separate component, wherein in particular the central element is designed as central sliding plate and the sliding plate formation consists of the two side sliding plates and the central sliding plate.

13. Wedge drive according to claim 1, characterized in that all the surfaces by which the first guiding element and the second guiding element are in contact with the sliding plates of the sliding plate formation for guiding the slider element to the slider element receptacle are designed as even surfaces that extend either perpendicularly to the cross direction (Y) or perpendicularly to the transverse cross direction (Z).

14. Wedge drive according to claim 1, characterized in that the slider element is designed as the first guiding element and the slider element receptacle as the second guiding element.

15. Wedge drive according to claim 1, characterized in that the side sliding plates differ in their length of extension in a direction that is perpendicular to the sliding direction (X) and perpendicular to the cross direction (Y) by less than 0.01 mm, wherein this length of extension is at least 10 mm.

16. Wedge drive according to claim 1, characterized in that the side sliding plates bear respectively on the first guiding element, on the central element and on the second guiding element, wherein the central element bears on the first guiding element and on the side sliding plates and in particular on the second guiding element.

17. Wedge drive according to claim 1, characterized in that slider sliding plates are provided on the slider element and driver sliding plates on the driver element, wherein the slider sliding plates and the driver sliding plates form a driver guiding for the linear guiding of the slider element along the driver element in a driver sliding direction, wherein the driver sliding direction extends in a plane that is perpendicular to the cross direction (Y), wherein the driver sliding direction forms an angle of at least 20°, in particular between 30° and 120° with the sliding direction (X).

18. Method for manufacturing a wedge drive according to claim 1, wherein a thickness of the two side sliding plates that the length of extension of the side sliding plates defines in a direction that is perpendicular to the sliding direction and perpendicular to the cross direction, when the side sliding plates are mounted in the wedge drive, is simultaneously and jointly adjusted by a tool, wherein in particular the width of exactly one of the side sliding plates that the length of extension of these side sliding plates defines along the cross direction, when this side sliding plate is mounted in the wedge drive, is adjusted by taking into account the distance between the steps of the second guiding element in the cross direction and the length of extension of the central element and of the other side sliding plate in the cross direction.
